(19) United States
(12) Patent Application Publication
(10) Pub. No.: US 2026/0225449 A1
(43) Pub. Date: Aug. 6, 2026

(54) IN-VEHICLE SYSTEM, AND INFORMATION PROCESSING DEVICE

(71) Applicant: TOYOTA JIDOSHA KABUSHIKI KAISHA, Toyota-shi (JP)

(72) Inventors: Hirotake SANO, Nagakute-shi (JP); Takashi Osawa, Toyota-shi (JP); Ryota Hamabe, Nisshin-shi (JP); Miki Tsujino, Ichinomiya-shi (JP); Shintaro Matsutani, Kariya-shi (JP); Hisashi Fujiwara, Nisshin-shi (JP)

(73) Assignee: TOYOTA JIDOSHA KABUSHIKI KAISHA, Toyota-shi (JP)

(21) Appl. No.: 19/420,815

(22) Filed: Dec. 16, 2025

(30) Foreign Application Priority Data
Feb. 4, 2025 (JP) 2025-016663

(51) Int. Cl. B60K 35/80; B60K 35/10

(52) U.S. Cl. CPC B60K 35/80; B60K 35/10; B60K 2360/115; B60K 2360/1434; B60K 2360/1468; B60K 2360/171; B60K 2360/782

(57) ABSTRACT

An in-vehicle system includes: a display device and an information processing device. The display device is provided at a front portion of a driver's seat in a vehicle cabin, and includes a pair of display units disposed at positions on both lateral sides of a steering wheel while protruding to a vehicle rear side of an instrument unit provided in front of the steering wheel, the display units each including a touch panel. The information processing device includes a control unit configured to output, to the display device, a command to cause the display units to display an operation screen for a power window that electrically opens and closes a window glass of a vehicle.

### CROSS-REFERENCE TO RELATED APPLICATION

This application claims priority to Japanese Patent Application No. 2025-016663 filed on February 4, 2025. The disclosure of the above-identified application, including the specification, drawings, and claims, is incorporated by reference herein in its entirety.

### BACKGROUND

### 1. Technical Field

The present disclosure relates to an in-vehicle system, and an information processing device.

### 2. Description of Related Art

There is known a doorknob of a vehicle including a touch panel having a function of an operation switch for a power window (for example, see Japanese Unexamined Patent Application Publication No. 2020-175763 (JP 2020-175763 A)).

### SUMMARY

The present disclosure provides an in-vehicle system and an information processing device for improving operability of a power window.

An in-vehicle system according to a first aspect of the present disclosure includes:

a display device; a power window configured to electrically open and close a window glass of a vehicle; and an information processing device configured to output information via the display device, in which:

the display device is provided at a front portion of a driver's seat in a vehicle cabin;

the display device includes a pair of display units disposed at positions on both lateral sides of a steering wheel while protruding to a vehicle rear side of an instrument unit provided in front of the steering wheel, the display units each including a touch panel;

the information processing device includes a control unit and a storage unit; and

the control unit is configured to:

output, in accordance with a signal received from the touch panel and information stored in the storage unit, a command to cause the display units to display an operation screen for the power window, to the display device;

identify a touch operation to the operation screen for the power window in accordance with a signal from the touch panel; and

output, to the power window, a command to open or close the window glass in accordance with the identified touch operation.

An in-vehicle system according to a second aspect of the present disclosure includes:

a display device; and an information processing device configured to output information via the display device, in which:

the display device is provided at a front portion of a driver's seat in a vehicle cabin;

the display device includes a pair of display units disposed at positions on both lateral sides of a steering wheel while protruding to a vehicle rear side of an instrument unit provided in front of the steering wheel, the display units each including a touch panel; and

the information processing device includes a control unit configured to output, to the display device, a command to cause the display units to display an operation screen for a power window that electrically opens and closes a window glass of a vehicle.

The display units may be disposed on a vehicle front side of a grasping portion of the steering wheel in a front-rear direction of the vehicle.

The control unit may be configured to: receive, from the display device, a touch signal relating to a touch operation to the touch panel; and output, in accordance with the touch signal, a command to open or close the window glass to the power window.

The control unit may be configured to: acquire information relating to an opening degree of the window glass; and output the command to the display device such that the information relating to the opening degree of the window glass is displayed on the operation screen for the power window.

The control unit may be configured to output the command to the display device such that, in the operation screen for the power window, a display mode is changed between an interface by which the window glass is operatable and an interface by which the window glass is not operatable.

The display units may be configured to include an inner display disposed closer to an inner side of the vehicle, and an outer display disposed closer to an outer side of the vehicle, and the control unit may be configured to output the command to the display device such that the operation screen for the power window is displayed on the outer display.

The control unit may be configured to: receive, from the display device, a touch signal relating to a touch operation to the touch panel; output, when it is determined in accordance with the touch signal that an interface corresponding to an operation of opening the window glass is touched for a predetermined time or more, a command to automatically fully open the window glass to the power window; and output, when it is determined in accordance with the touch signal that an interface corresponding to an operation of closing the window glass is touched for a predetermined time or more, a command to automatically fully close the window glass to the power window.

An information processing device according to a third aspect to the present disclosure is an information processing device that outputs information via a display device, in which:

the information processing device includes a control unit;

the display device is provided at a front portion of a driver's seat in a vehicle cabin;

the display device includes a pair of display units disposed at positions on both lateral sides of a steering wheel while protruding to a vehicle rear side of an instrument unit provided in front of the steering wheel, the display units each including a touch panel; and

the control unit is configured to output, to the display device, a command to cause the display units to display an operation screen for a power window that electrically opens and closes a window glass of a vehicle.

In the information processing device according to the third aspect of the present disclosure, the display units may be disposed on a vehicle front side of a grasping portion of the steering wheel in a front-rear direction of the vehicle.

In the information processing device according to the third aspect of the present disclosure, the control unit may be configured to: receive, from the display device, a touch signal relating to a touch operation to the touch panel; and output, in accordance with the touch signal, a command to open or close the window glass to the power window.

In the information processing device according to the third aspect of the present disclosure, the control unit may be configured to: acquire information relating to an opening degree of the window glass; and output the command to the display device such that the information relating to the opening degree of the window glass is displayed on the operation screen for the power window.

In the information processing device according to the third aspect of the present disclosure, the control unit may be configured to output the command to the display device such that, in the operation screen for the power window, a display mode is changed between an interface by which the window glass is operatable and an interface by which the window glass is not operatable.

In the information processing device according to the third aspect of the present disclosure, the display units may be configured to include an inner display disposed closer to an inner side of the vehicle, and an outer display disposed closer to an outer side of the vehicle, and the control unit may be configured to output the command to the display device such that the operation screen for the power window is displayed on the outer display.

In the information processing device according to the third aspect of the present disclosure, the control unit may be configured to: receive, from the display device, a touch signal relating to a touch operation to the touch panel; output, when it is determined in accordance with the touch signal that an interface corresponding to an operation of opening the window glass is touched for a predetermined time or more, a command to automatically fully open the window glass to the power window; and output, when it is determined in accordance with the touch signal that an interface corresponding to an operation of closing the window glass is touched for a predetermined time or more, a command to automatically fully close the window glass to the power window.

Further, another aspect of the present disclosure relates to a vehicle having the above-mentioned in-vehicle system installed thereon, an information processing method to be executed by the above-mentioned information processing device, a program for causing a computer to execute the information processing method, or a computer-readable storage medium having the program non-temporarily stored therein.

With the present disclosure, the operability of the power window can be improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view illustrating an inside of a vehicle cabin of a vehicle;

FIG. 2 is an enlarged view of a region around a steering wheel;

FIG. 3 is a diagram schematically illustrating an example of a hardware configuration of the vehicle;

FIG. 4 is a top view of the vehicle;

FIG. 5 is an exemplary diagram illustrating a functional configuration of an ECU;

FIG. 6 is a view illustrating an example of a power window operation screen to be displayed on an outer display;

FIG. 7 is a view illustrating an example of the power window operation screen to be displayed on the outer display when a user touches a window lock button;

FIG. 8 is a view illustrating an example of the power window operation screen to be displayed on the outer display when a GUI component provided to operate a front right power window is hidden;

FIG. 9 is a flowchart of a process in the ECU at the time of an operation of a power window by the power window operation screen according to a first embodiment;

FIG. 10 is a view illustrating an example of a power window operation screen to be displayed on an outer display according to a second embodiment;

FIG. 11 is a flowchart of a process in an ECU at the time of an operation of a power window by the power window operation screen according to the second embodiment; and

FIG. 12 is a view illustrating an example of a power window operation screen to be displayed on an outer display according to a third embodiment.

### DETAILED DESCRIPTION OF EMBODIMENTS

There has been known a power window that uses an electric motor to open and close a window glass provided to a door of a vehicle. The power window can be operated by, for example, a switch provided to the door. Further, in order to allow opening and closing of all window glasses to be operated from a driver's seat, a plurality of switches is provided in some cases. When a driver shifts the driver's line of sight to the switch when operating such switches during travel of the vehicle, the driver's line of sight greatly moves from the front side. Such movement of the line of sight of the driver is preferably minimized.

In contrast, an in-vehicle system that is one aspect of the present disclosure is an in-vehicle system including a display device and an information processing device that outputs information via the display device. The display device is provided at a front portion of a driver's seat in a vehicle cabin, and includes a pair of display units disposed at positions on both lateral sides of a steering wheel while protruding to a vehicle rear side of an instrument unit provided in front of the steering wheel, the display units each including a touch panel.

The display device includes the display units disposed at positions on both lateral sides of the steering wheel. Further, the display units each have a configuration that allows a touch operation by a touch panel. The display units are preferably disposed at positions protruding to a rear side of the vehicle from the instrument unit (typically, a meter panel in which a speedometer is disposed) provided in front of the steering wheel, in a front-rear direction of the vehicle, that is, at positions close to the driver. With the display units being provided to such positions, the touch panel can be disposed in the vicinity of a part of the steering wheel to be grasped by the driver. That is, at the time of the operation, the time for which the driver takes off the hand from the steering wheel can be minimized. It is to be noted that the steering wheel is not always required to have a circular shape as long as the steering wheel includes a grasping portion and can be rotated to perform a steering operation.

The display units present, for example, information relating to control of the vehicle or information relating to convenience of an occupant of the vehicle to the user. The information relating to the convenience of the occupant of the vehicle may include information for providing entertainment to the occupant of the vehicle, information relating to comfort of the occupant, or the like. Examples of the information relating to the comfort or the convenience of the occupant include information relating to an interface provided to perform an operation of audio, navigation, an air conditioner, a phone, a clock, a voice assistance, or the like, and information relating to an actuation state of those devices. Further, the information relating to the control of the vehicle may include information relating to travel of the vehicle. Examples of the information relating to the control of the vehicle include information relating to an interface provided to perform an operation of a headlight, a wiper, a side-view mirror, an advanced driver assistance system (ADAS), a drive mode, a vehicle height, a position of the steering wheel, a position of a seat, or the like, and information relating to actuation states of those devices.

Here, the information processing device includes a control unit configured to output, to the display device, a command to cause the display units to display an operation screen for a power window that electrically opens and closes a window glass of the vehicle. With this command, the operation screen for the power window is displayed on the display device. When the driver touches the operation screen to operate the power window, the driver can operate the power window even without greatly moving the line of sight.

Hereinafter, with reference to the drawings, embodiments of the present disclosure will be described. The configurations of the following embodiments are exemplary, and the present disclosure is not limited to the configurations of the embodiments. Further, the following embodiments can be combined to the extent possible.

### First Embodiment

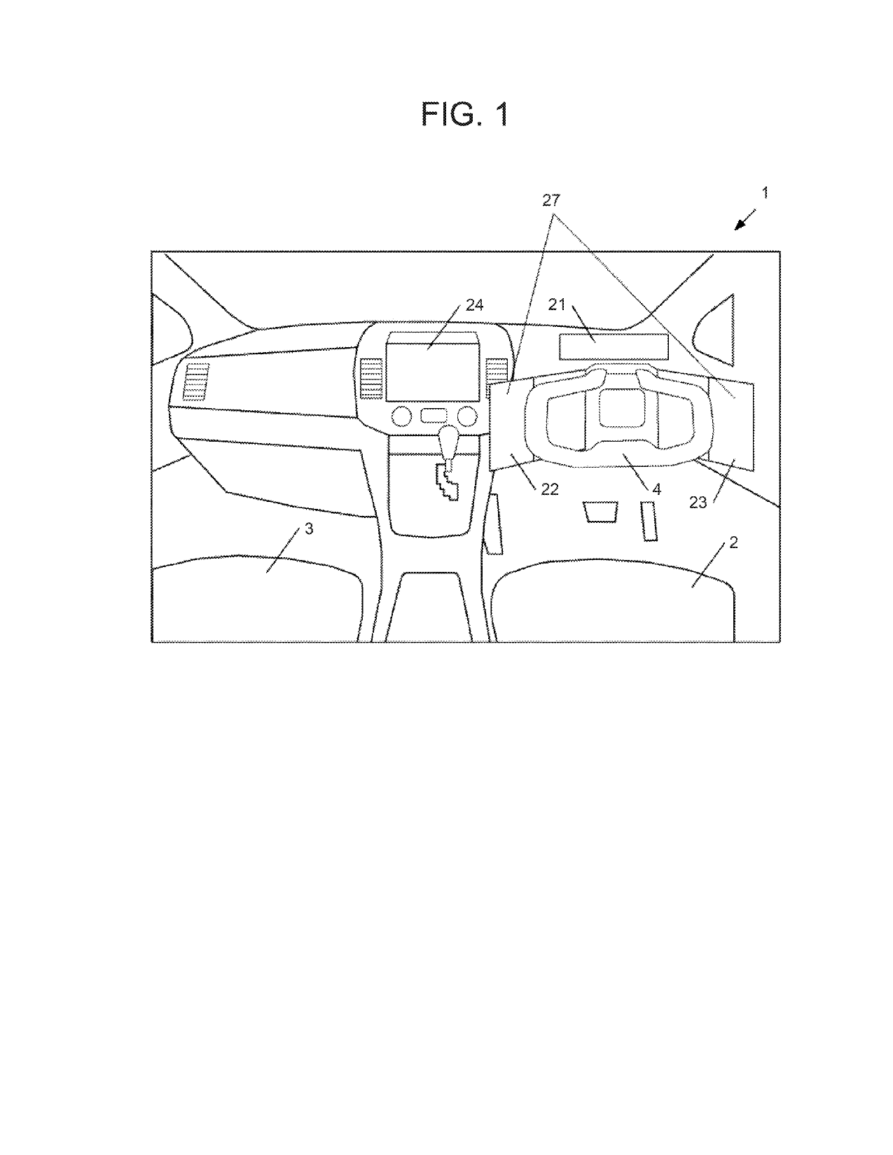

FIG. 1 is a view illustrating an inside of a vehicle cabin of a vehicle 1. As illustrated, in the vehicle cabin of the vehicle 1, a driver's seat 2 and a passenger seat 3 are provided. It is to be noted that the vehicle 1 of the present embodiment is a right-hand drive vehicle, and the driver's seat 2 is provided on the right side of the vehicle. A steering wheel 4 is provided on the front side of the driver's seat 2. It is to be noted that the steering wheel 4 may have a circular shape, or, as illustrated, a U-shaped one (what is called an odd-shaped steering wheel) may be used. The steering wheel 4 is connected to a steering device included in the vehicle 1 via a steering column. The steering column is covered with a column cover.

The passenger seat 3 is provided on the left side of the driver's seat 2, and a center display 24 is provided on a vehicle front side at an intermediate position between the driver's seat 2 and the passenger seat 3. The center display 24 displays, for example, supplementary information such as car navigation, content relating to entertainment such as audio or television, or the like.

A meter display 21 is provided on the vehicle front side of the steering wheel 4. The meter display 21 is a full-screen display that is positioned in front of the driver's seat 2 and provides various types of information to the driver of the vehicle 1. The meter display 21 displays, for example, information required for the vehicle to travel, such as a speed of the vehicle (vehicle speed), an engine speed (when the vehicle 1 includes an engine), a charging-discharging state (when the vehicle 1 includes a driving battery), and a traveling distance. The meter display 21 is an example of an "instrument unit" in the present disclosure.

In a front portion of the driver's seat 2 in the vehicle cabin, a pair of displays 27 is provided. The displays 27 include touch panel displays respectively disposed at positions on both lateral sides of the steering wheel 4. The pair of displays 27 is an example of “pair of display units” in the present disclosure. The displays 27 are configured to include an inner display 22 and an outer display 23. In the present embodiment, a display 22 disposed closer to the inner side of the vehicle is referred to as an inner display 22, and a display 23 disposed closer to the outer side of the vehicle is referred to as an outer display 23. The inner display 22 and the outer display 23 are connected to an instrument panel of the vehicle 1.

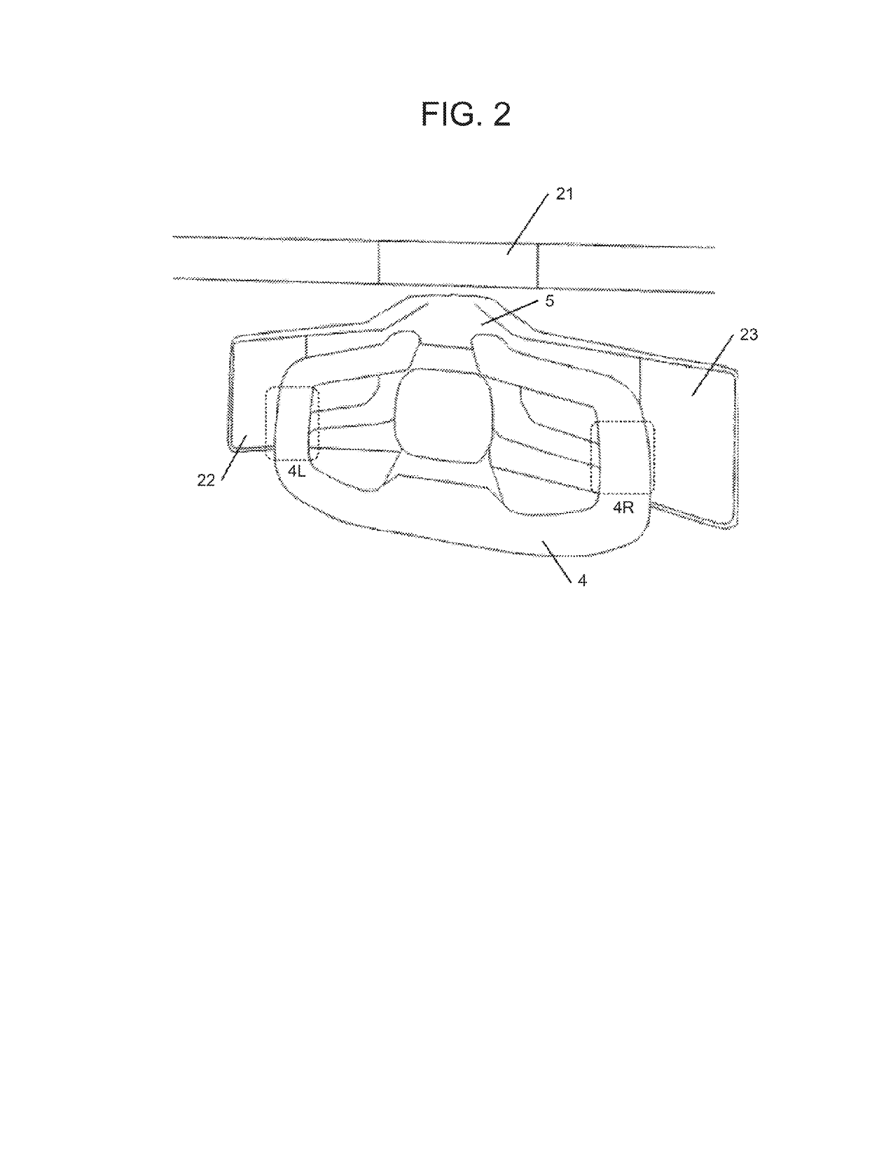

With reference to FIG. 2, detailed structures of the inner display 22 and the outer display 23 are described. FIG. 2 is an enlarged view of a region around the steering wheel 4. The inner display 22 and the outer display 23 are vertically long displays, and are connected to a support portion 5 that is a member that supports the displays. The support portion 5 has a shape protruding in a right-left direction of the steering wheel. The outer display 23 is connected to an end portion of the support portion 5 on the right side when facing the vehicle front side, and the inner display 22 is connected to an end portion of the support portion 5 on the left side when facing the vehicle front side. This makes it possible to dispose a display displaying surface in the vicinity of the grasping portion of the steering wheel 4.

It is to be noted that the description above is an example of a case in which the vehicle 1 is a right-hand drive vehicle, but the right and left sides are reversed when the vehicle 1 is a left-hand drive vehicle. That is, there is employed a mode in which the outer display 23 is connected to the end portion of the support portion 5 on the left side when facing toward the vehicle front side, and the inner display 22 is connected to the end portion of the support portion 5 on the right side when facing toward the vehicle front side.

The support portion 5 may also serve as the column cover that covers the steering column. The support portion 5 has a shape of, from a part through which the steering column passes, each extending in the right-left direction (vehicle width direction) and then extending to the vehicle rear side, and bending in the middle so that an angle with respect to the right-left direction of the steering wheel 4 is reduced.

Further, the inner display 22 and the outer display 23 each have an angle with respect to the right-left direction of the steering wheel, and are each disposed so as to be inclined to the steering wheel side. That is, the inner display 22 is disposed to protrude rearward of the vehicle 1 as coming closer to the inner side of the vehicle 1, and the outer display 23 is disposed to protrude rearward of the vehicle 1 as coming closer to the outer side of the vehicle 1. As described above, the inner display 22 and the outer display 23 are each disposed to be directed toward the driver.

A region 4R indicated by the broken line in FIG. 2 is a part of the steering wheel 4 to be grasped by the right hand (grasping portion), and a region 4L indicated by the broken line in FIG. 2 is a part of the steering wheel 4 to be grasped by the left hand (grasping portion). The inner display 22 and the outer display 23 are disposed on the vehicle front side from the grasping portion of the steering wheel 4 in the front-rear direction of the vehicle 1. With the support portion 5 having the above-mentioned shape, the positions of the inner display 22 and the outer display 23 in the vehicle front-rear direction can be brought closer to the grasping portions of the steering wheel 4. Accordingly, the movement amount of the hand when the driver performs the touch operation to the inner display 22 or the outer display 23 during driving can be further reduced.

The meter display 21, the inner display 22, and the outer display 23 are each a display including a touch panel. It is to be noted that the touch panel is only required to be included in at least the inner display 22 and the outer display 23. As the touch panel, for example, a pressure-sensitive touch panel that detects a pressure of pressing the panel by the user, a capacitive touch panel that detects a change of capacitance when the user presses the panel, and the like can be adopted. Examples of the display include a liquid crystal display (LCD) and an electroluminescence (EL) panel.

The inner display 22 displays, for example, information relating to convenience of the occupant of the vehicle 1. The information relating to convenience of the occupant of the vehicle 1 includes information for providing entertainment to the occupant of the vehicle 1. The information relating to convenience of the occupant of the vehicle 1 may include information relating to comfort of the occupant or the like. Examples of the information relating to the comfort and the convenience of the occupant include information relating to switches, buttons, and the like to perform an operation of audio, an operation of a navigation device, an operation of an air conditioner, an operation of a phone, an operation of a clock, an operation of a voice assistance, or the like, and information relating to actuation states of those devices.

The outer display 23 displays, for example, information relating to control of the vehicle 1. The information relating to control of the vehicle 1 includes information relating to travel of the vehicle 1. Examples of the information relating to control of the vehicle 1 include information relating to switches, buttons, and the like to perform an operation of a power window, an operation of a headlight, an operation of a wiper, an operation of a side-view mirror, an operation of an ADAS, an operation of a drive mode, an operation of a suspension, an operation of a position of the steering wheel, an operation of a position of a seat, or the like, and information relating to actuation states of those devices. With the information relating to control of the vehicle 1 being displayed on the outer display 23, it is possible to prevent a passenger other than the driver from operating the information relating to control of the vehicle 1.

It is to be noted that the information to be displayed on the inner display 22 and the outer display 23 is not limited to those above. The inner display 22 may display the information relating to control of the vehicle 1, and the outer display 23 may display the information relating to convenience of the occupant of the vehicle 1. Further, the information to be displayed on the inner display 22 and the outer display 23 can be freely decided.

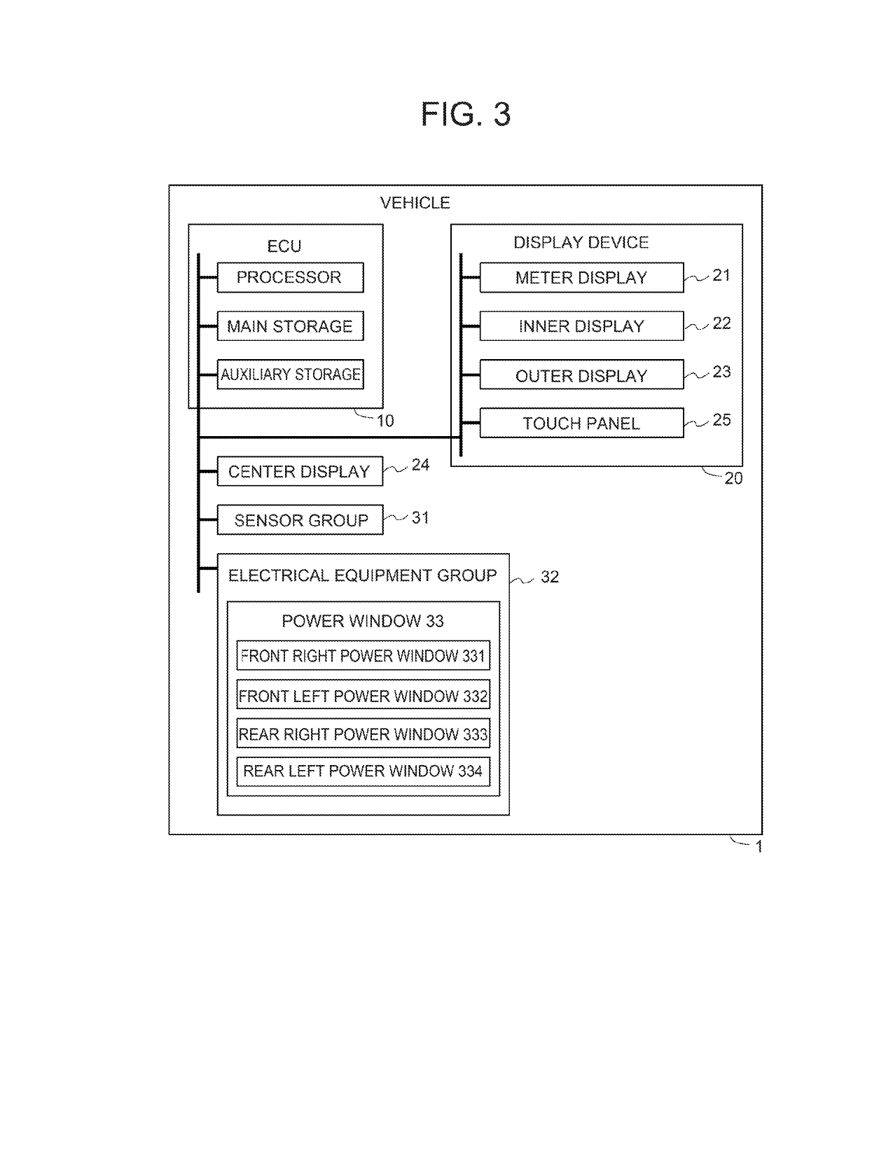

FIG. 3 is a diagram schematically illustrating an example of a hardware configuration of the vehicle 1. The vehicle 1 includes an ECU 10, a display device 20, a center display 24, a sensor group 31, and an electrical equipment group 32. The ECU 10 can be configured of a computer including a processor (CPU, GPU, or the like), a main storage (RAM, ROM, or the like), and an auxiliary storage (EPROM, hard disk drive, removable medium, or the like). In the auxiliary storage, an operating system (OS), various programs, various tables, and the like are stored, and functions (software modules) matching a predetermined object can be implemented as described later by executing the program stored in the auxiliary storage. However, some or all of the functions may be implemented as a hardware module by a hardware circuit such as an ASIC or an FPGA. The display device 20, the center display 24, the sensor group 31, and the electrical equipment group 32 are connected to the ECU 10. The ECU 10 is an example of the information processing device.

The display device 20 includes the meter display 21, the inner display 22, the outer display 23, and a touch panel 25. The touch panel 25 is a unit that detects a touch operation performed on the meter display 21, the inner display 22, or the outer display 23. The touch panel 25 is disposed in each of the meter display 21, the inner display 22, and the outer display 23 to allow an operation by touch.

The sensor group 31 is a set of a plurality of sensors provided to acquire sensor data to be used in travel of the vehicle 1. The sensor may acquire a physical quantity, or acquire image data or the like. The sensor group 31 includes, for example, a sensor that detects the state of the vehicle 1, a sensor that detects a motion of the driver, and the like. The sensor group 31 includes, for example, a speed sensor, an acceleration sensor, an accelerator operation amount sensor that detects a position of an accelerator pedal, a brake sensor that detects a position of a brake pedal, a steering-wheel angle sensor that detects an angle of the steering wheel, an engine rotation speed sensor that detects a rotation speed of the engine, a coolant temperature sensor that detects a temperature of a coolant of the engine, an oil temperature sensor that detects a temperature of oil of the engine, an oil pressure sensor that detects a pressure of the oil of the engine, a sensor that detects a pressure of intake air of the engine, a yaw rate sensor, a turn signal switch sensor (a sensor that detects a state of a switch of a direction indicator), a shift position sensor, a sensor that detects positional information (a GPS sensor), a sensor that detects a vehicle interior temperature, a sensor that detects a vehicle exterior temperature, a radar that measures a distance to an object, and the like.

The electrical equipment group 32 is a set of pieces of electrical equipment to be used in the vehicle 1. The electrical equipment group 32 includes a power window 33. It is to be noted that the electrical equipment group 32 can further include an air conditioner, a suspension, a massage seat, a navigation device, an audio device, a phone, a wiper, a headlight, a side-view mirror, and a voice assistance.

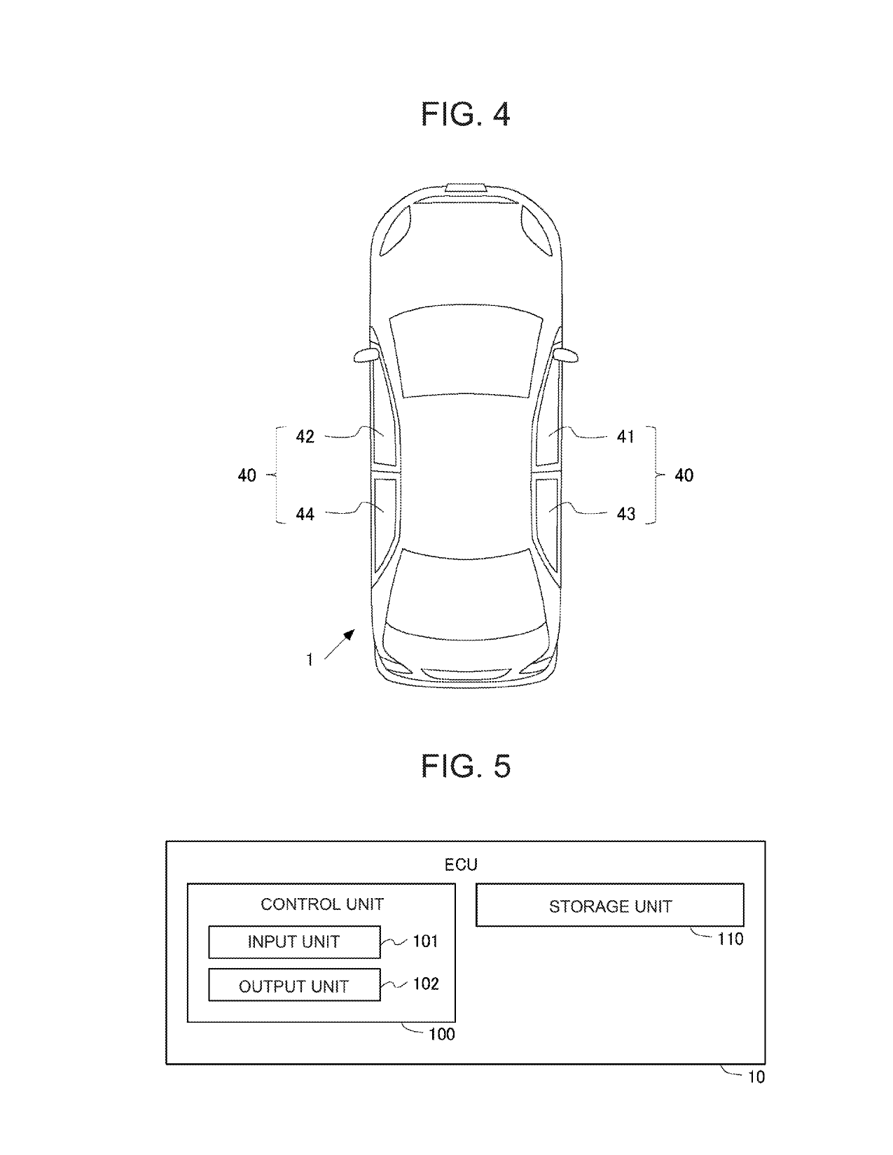

Here, FIG. 4 is a top view of the vehicle 1. The vehicle 1 includes a front right window glass 41 provided in a front right door of the vehicle 1, a front left window glass 42 provided in a front left door, a rear right window glass 43 provided in a rear right door, and a rear left window glass 44 provided in a rear left door. It is to be noted that, when the front right window glass 41, the front left window glass 42, the rear right window glass 43, and the rear left window glass 44 are not distinguished, the window glass is simply referred to as a window glass 40. The power window 33 is a device that automatically opens and closes the window glass 40 through a switch operation performed by the user. The power window 33 includes a front right power window 331 that opens and closes the front right window glass 41, a front left power window 332 that opens and closes the front left window glass 42, a rear right power window 333 that opens and closes the rear right window glass 43, and a rear left power window 334 that opens and closes the rear left window glass 44. The front right door is a door on the driver's seat 2 side, and the front left door is a door on the passenger seat 3 side. It is to be noted that the present embodiment describes a case in which the vehicle 1 includes four windows, but the present disclosure is not limited thereto. For example, in a vehicle including two windows, the rear right power window 333 and the rear left power window 334 can be omitted. Each door includes an operation switch used to open and close the window glass of the door. The operation switch is a physical switch, and the window glass 40 is lowered when the user presses the operation switch downward, and the window glass 40 is raised when the user pulls the operation switch upward.

FIG. 5 is an exemplary diagram illustrating a functional configuration of the ECU 10. The ECU 10 includes, as functional components, a control unit 100 and a storage unit 110. The control unit 100 is, for example, a functional component provided by the processor executing various programs stored in the auxiliary storage. The control unit 100 includes an input unit 101 and an output unit 102. The storage unit 110 is means for storing information, and is configured to include a main storage and an auxiliary storage.

The input unit 101 receives a touch signal from the touch panel 25 to determine an input operation performed by the user via the touch panel 25, and executes information processing corresponding to the determined input operation. In the embodiment, a touch signal transmitted from the touch panel 25 to the control unit 100 at least includes information indicating a touch position (a position touched by the finger of the user) on a screen of the outer display 23. The output unit 102 generates a screen to be displayed on the inner display 22 and the outer display 23. For example, the output unit 102 generates a home screen at the time of normal travel.

Here, when a touch operation is performed on a graphical user interface (GUI) component that invokes the operation screen for the power window 33 in the home screen or a menu screen displayed on the outer display 23, the input unit 101 identifies that the touch position is a display position of the GUI component in accordance with the touch signal received from the touch panel 25. It is to be noted that information relating to the display position of the GUI component corresponding to each item included in the menu screen is stored in advance in the storage unit 110.

Further, the output unit 102 generates the operation screen for the power window 33 in accordance with the touch by the user of a GUI component provided to transition to the operation screen for the power window 33. Then, the output unit 102 outputs, to the display device 20, a command to display the operation screen for the power window. At this time, the output unit 102 may transmit, to the display device 20, a command to display the operation screen for the power window 33 on the outer display 23.

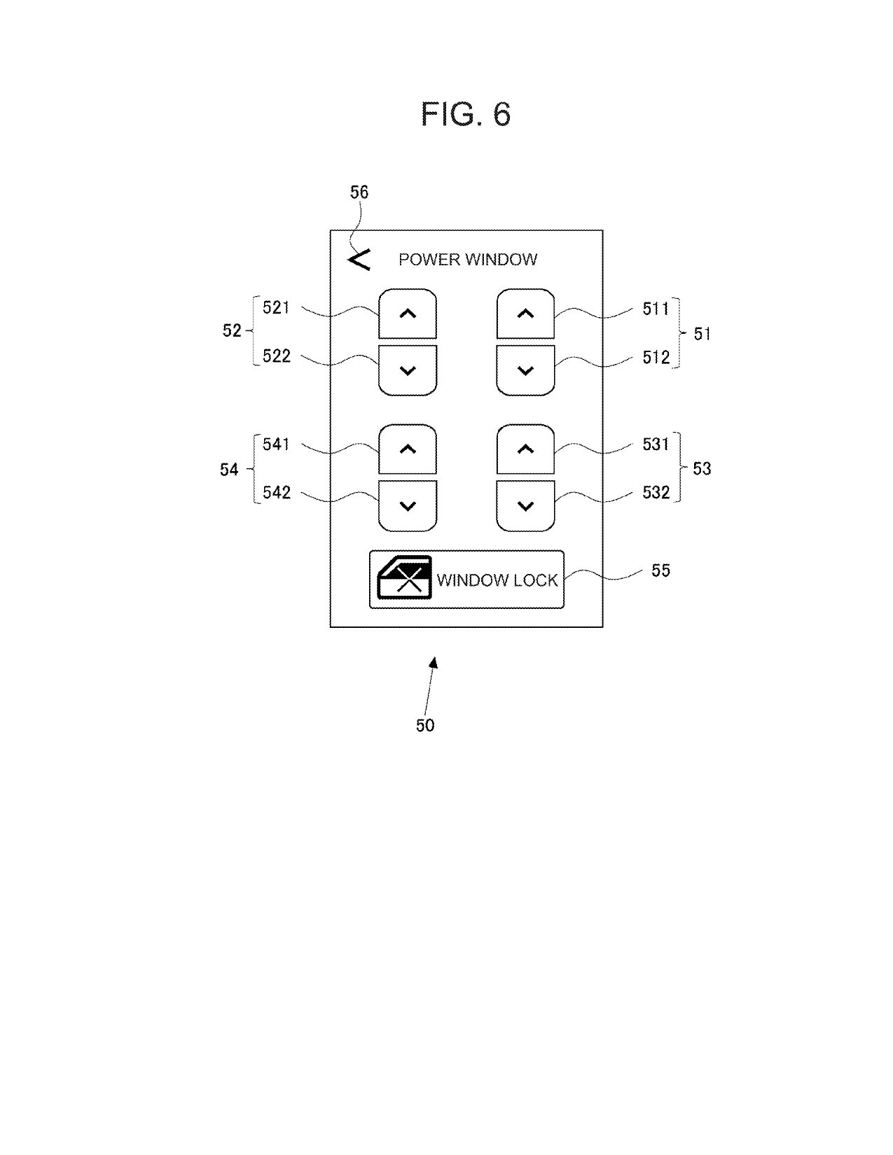

FIG. 6 is a view illustrating an example of a power window operation screen 50 to be displayed on the outer display 23. The power window operation screen 50 includes a GUI component 51 provided to operate the front right power window 331, a GUI component 52 provided to operate the front left power window 332, a GUI component 53 provided to operate the rear right power window 333, a GUI component 54 provided to operate the rear left power window 334, a GUI component 55 provided to inhibit the operation of the power window 33, that is, to perform window lock (hereinafter also referred to as a window lock button 55), and a GUI component 56 provided to return to the home screen or the menu screen (hereinafter also referred to as an end button 56).

The GUI component 51 provided to operate the front right power window 331 includes a GUI component 511 provided to raise the front right window glass 41 and a GUI component 512 provided to lower the front right window glass 41. Further, the GUI component 52 provided to operate the front left power window 332 includes a GUI component 521 provided to raise the front left window glass 42 and a GUI component 522 provided to lower the front left window glass 42. Further, the GUI component 53 provided to operate the rear right power window 333 includes a GUI component 531 provided to raise the rear right window glass 43 and a GUI component 532 provided to lower the rear right window glass 43. Further, the GUI component 54 provided to operate the rear left power window 334 includes a GUI component 541 provided to raise the rear left window glass 44 and a GUI component 542 provided to lower the rear left window glass 44.

The GUI component 55 provided to inhibit the operation of the power window 33 is a GUI component provided to perform window lock, and is a GUI component provided to inhibit any of an operation performed by the operation switch for the power window 33 provided in each door, and a touch operation to each GUI component displayed on the power window operation screen 50. It is to be noted that, even when the operation of the power window 33 is inhibited (a state in which window lock is performed), it may be possible to perform only the opening-closing operation of the window glass on the driver's seat side, that is, the front right window glass 41.

When the touch operation is performed on any one of the plurality of GUI components 51 to 56 described above in a state in which the power window operation screen 50 exemplified in FIG. 6 is displayed on the outer display 23, a touch signal including information indicating the touch position in the outer display 23 is transmitted from the touch panel 25 to the control unit 100. The input unit 101 determines, in accordance with the touch signal, on which display position of the GUI component out of the GUI components 51 to 56 described above the touch operation has been performed. At this time, information relating to the display positions of the GUI components 51 to 56 described above is stored in advance in the storage unit 110.

Further, the output unit 102 transmits a command to the power window 33 in accordance with the GUI component touched by the user in the power window operation screen 50. When the GUI component 511 provided to raise the front right window glass 41 is touched, the output unit 102 transmits a command to raise the front right window glass 41 to the front right power window 331. When the GUI component 512 provided to lower the front right window glass 41 is touched, the output unit 102 transmits a command to lower the front right window glass 41 to the front right power window 331. When the GUI component 521 provided to raise the front left window glass 42 is touched, the output unit 102 transmits a command to raise the front left window glass 42 to the front left power window 332. When the GUI component 522 provided to lower the front left window glass 42 is touched, the output unit 102 transmits a command to lower the front left window glass 42 to the front left power window 332. When the GUI component 531 provided to raise the rear right window glass 43 is touched, the output unit 102 transmits a command to raise the rear right window glass 43 to the rear right power window 333. When the GUI component 532 provided to lower the rear right window glass 43 is touched, the output unit 102 transmits a command to lower the rear right window glass 43 to the rear right power window 333. When the GUI component 541 provided to raise the rear left window glass 44 is touched, the output unit 102 transmits a command to raise the rear left window glass 44 to the rear left power window 334. When the GUI component 542 provided to lower the rear left window glass 44 is touched, the output unit 102 transmits a command to lower the rear left window glass 44 to the rear left power window 334. When the window lock button 55 is touched, the output unit 102 transmits a command to inhibit raising and lowering of the front left window glass 42, the rear right window glass 43, and the rear left window glass 44 to the power window 33.

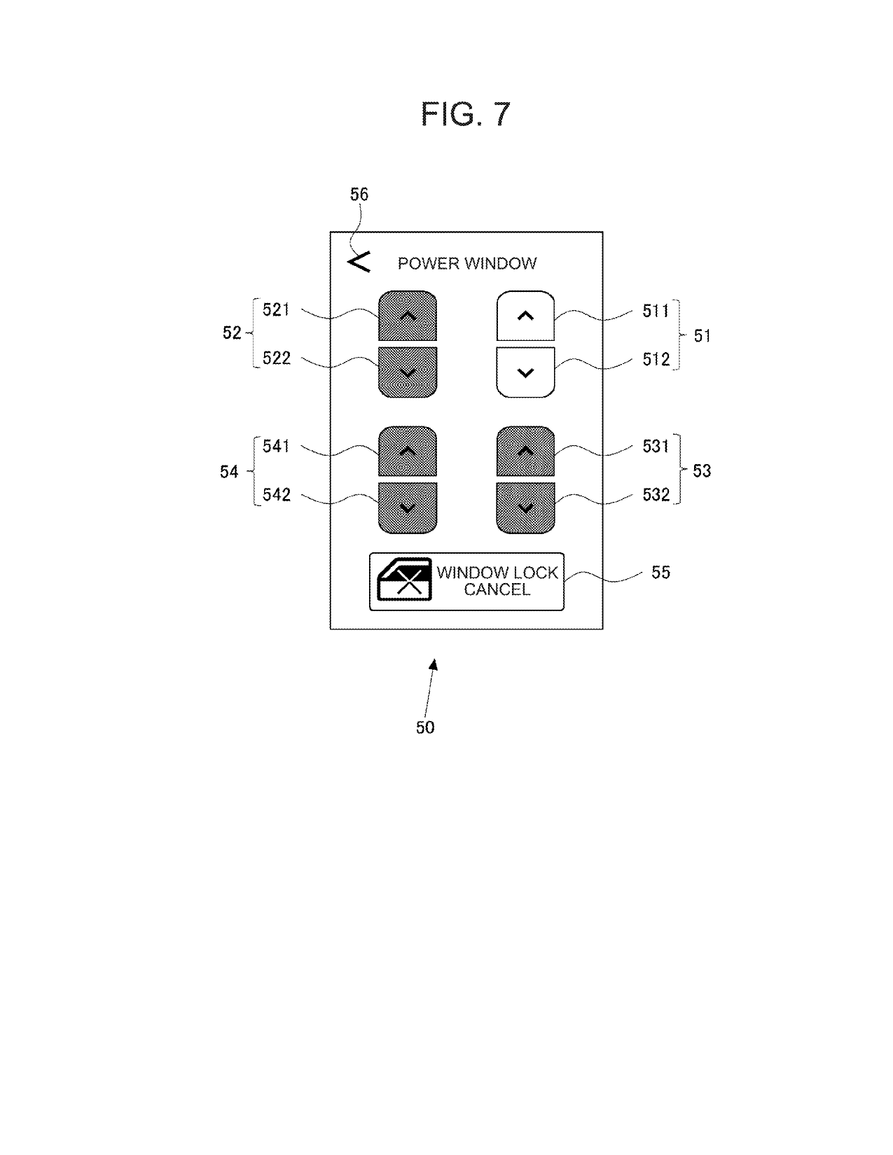

Further, FIG. 7 is a view illustrating an example of the power window operation screen 50 to be displayed on the outer display 23 when the user touches the window lock button 55. When the input unit 101 determines that the user has touched the window lock button 55, the output unit 102 grays out the GUI components 52 to 54 corresponding to the front left window glass 42, the rear right window glass 43, and the rear left window glass 44 for which the operation is inhibited. That is, the output unit 102 changes the display mode between the GUI component that can be operated and the GUI component that cannot be operated. Further, the output unit 102 transmits a command to perform the window lock to the power window 33. After that, even when an occupant touches the GUI components 52 to 54 or operates the operation switch provided in each door, the output unit 102 and the power window 33 does not accept the operations of the front left window glass 42, the rear right window glass 43, and the rear left window glass 44. Further, the output unit 102 changes a text displayed on the window lock button 55 from "window lock" to "window lock cancel". When the user touches the window lock button 55 again, the output unit 102 transmits a command to cancel the window lock to the power window 33. Further, the output unit 102 restores the grayed out GUI components 52 to 54 to normal display. Moreover, the output unit 102 changes the text displayed on the window lock button 55 from "window lock cancel" to "window lock".

It is to be noted that the raising and lowering of the window glass 40 may be performed only when the user touches any one of the GUI components 51 to 54. Further, when the GUI components 51 to 54 are touched for a predetermined time or more, the raising and lowering of the window glass 40 may be automatically continued even when the user does not touch the screen any more. At this time, a sound may be output or the outer display 23 may be vibrated as an answerback. As described above, when any one of the GUI components 51 to 54 is held down by the user, the window glass 40 can be automatically opened and closed.

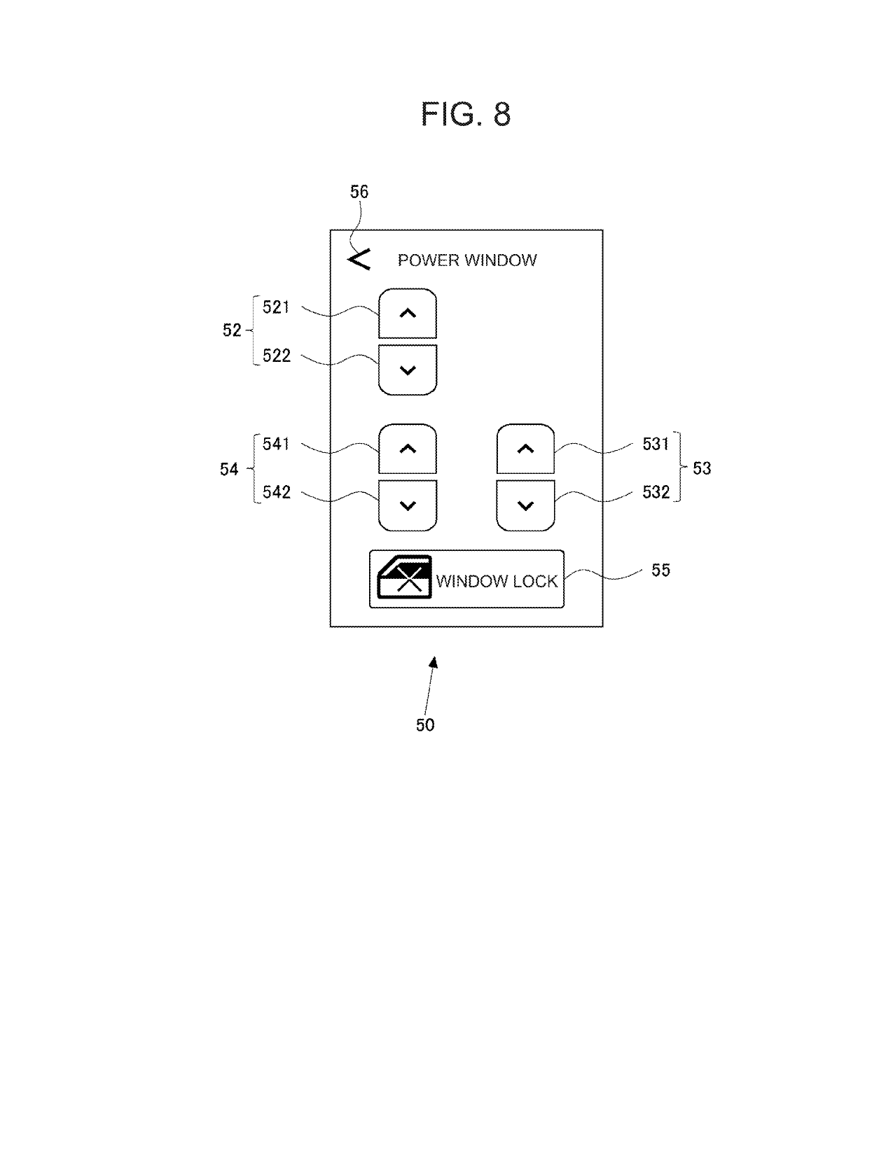

Here, FIG. 8 is a view illustrating an example of the power window operation screen 50 to be displayed on the outer display 23 when the GUI component 51 provided to operate the front right power window 331 is hidden. For example, when the window glass on the driver's seat 2 side, that is, the front right window glass 41 is to be closed, a motion of pulling up a switch may be required by law. In an area in which such a law is defined, the GUI component 51 provided to operate the front right power window 331 may be hidden. This makes it possible to operate the front right window glass 41 only by a physical switch disposed in the door of the driver's seat 2, for example.

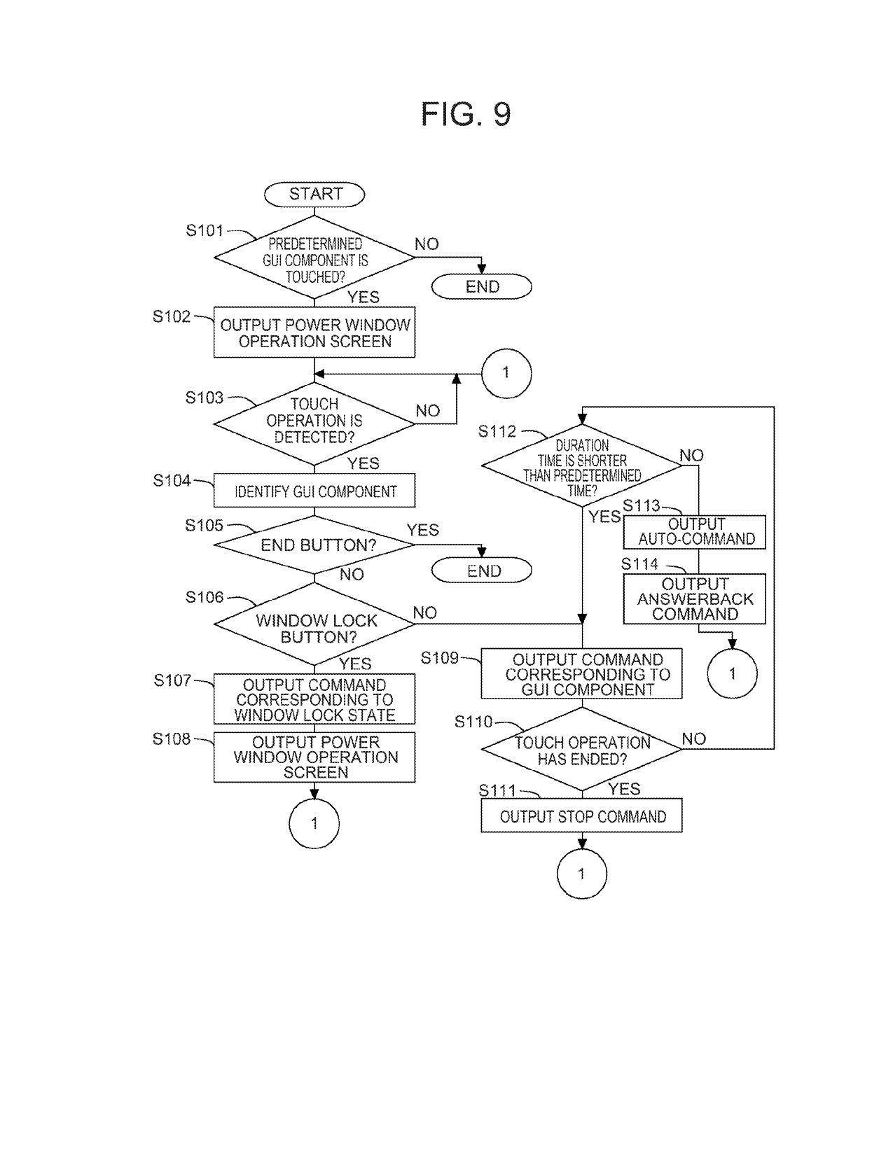

FIG. 9 is a flowchart of a process in the ECU 10 at the time of operating the power window 33 by the power window operation screen 50 according to a first embodiment. The process illustrated in FIG. 9 is repeatedly executed in the ECU 10 at every predetermined time.

In step S101, the input unit 101 determines whether or not the user has touched a predetermined GUI component displayed on the touch panel 25. The predetermined GUI component is a GUI component provided to change the screen from the home screen or the menu screen to the power window operation screen 50. The input unit 101 determines whether or not the touch operation to the predetermined GUI component has been performed in accordance with the touch signal from the touch panel 25. When the input unit 101 makes a positive determination in step S101, the process proceeds to step S102, and, when the input unit 101 makes a negative determination, the routine is ended.

In step S102, the output unit 102 outputs, to the outer display 23, a command to display the power window operation screen 50. At this time, the output unit 102 identifies a text to be displayed on the window lock button 55 in accordance with the state of the window lock stored in the storage unit 110. Then, the power window operation screen 50 is generated such that any one of the screens illustrated in FIG. 6 to FIG. 8 is displayed in accordance with the state of the window lock. The output unit 102 transmits, to the outer display 23, a command to cause the outer display 23 to display the generated power window operation screen 50.

In step S103, the input unit 101 determines whether or not the touch operation to the power window operation screen 50 has been detected. The input unit 101 determines whether or not the touch operation to the power window operation screen 50 has been performed in accordance with the touch signal from the touch panel 25. When the input unit 101 makes a positive determination in step S103, the process proceeds to step S104, and, when the input unit 101 makes a negative determination, the input unit 101 executes the process of step S103 again. It is to be noted that, when no touch operation is detected even after a certain time elapses, the output unit 102 may transmit a command to the outer display 23 to return to the home screen, and the routine may be ended.

In step S104, the input unit 101 identifies the GUI component touched by the user. The input unit 101 identifies the GUI component touched by the user in accordance with the position touched by the user detected by the touch panel 25 and the position of each GUI component illustrated in FIG. 6 to FIG. 8. It is to be noted that the position of each GUI component of the power window operation screen 50 displayed on the outer display 23 at the current time point is stored in the storage unit 110.

In step S105, the input unit 101 determines whether or not the GUI component identified in step S104 is the end button 56. When the input unit 101 makes a positive determination in step S105, the routine is ended, and, when the input unit 101 makes a negative determination, the process proceeds to step S106.

In step S106, the input unit 101 determines whether or not the GUI component identified in step S104 is the window lock button 55. When the input unit 101 makes a positive determination in step S106, the process proceeds to step S107, and, when the input unit 101 makes a negative determination, the process proceeds to step S109.

In step S107, the output unit 102 outputs, to the power window 33, a command corresponding to the state of the window lock. The output unit 102 generates a command to perform window lock when the window lock is canceled at the current time point, and outputs the command to the power window 33. This command is a command to inhibit the operation of the front left window glass 42, the rear right window glass 43, and the rear left window glass 44. Meanwhile, when the window lock is performed at the current time point, the output unit 102 generates a command to cancel the window lock, and outputs the command to the power window 33. This command is a command to accept the operation of the front left window glass 42, the rear right window glass 43, and the rear left window glass 44.

In step S108, the output unit 102 outputs, to the outer display 23, a command to display the power window operation screen 50. When the command to perform window lock is generated in step S107, the output unit 102 generates the power window operation screen 50 such that the text of the window lock button 55 is changed from "window lock" to "window lock cancel", and outputs the generated power window operation screen 50. Meanwhile, when the command to cancel the window lock is generated in step S107, the output unit 102 generates the power window operation screen 50 such that the text of the window lock button 55 is changed from "window lock cancel" to "window lock", and outputs the generated power window operation screen 50. After that, the process returns to step S103.

In step S109, the output unit 102 outputs, to the power window 33, a command corresponding to the GUI component identified in step S104. That is, the output unit 102 transmits a command to the power window 33 in accordance with the GUI component touched by the user in the power window operation screen 50. In accordance with the command, the power window 33 actuates a corresponding motor to raise or lower the corresponding window glass 40.

In step S110, the input unit 101 determines whether or not the touch operation by the user has ended. At this time, the input unit 101 determines whether or not the user has separated the finger from the touch panel 25 in accordance with a touch signal from the touch panel 25. When the input unit 101 makes a positive determination in step S110, the process proceeds to step S111, and, when the input unit 101 makes a negative determination, the process proceeds to step S112.

In step S111, the output unit 102 outputs, to the power window 33, a command (stop command) to stop the power window 33 actuated in step S109. In this case, the power window 33 is actuated only while the user touches the power window operation screen 50. After that, the process returns to step S103.

In step S112, the input unit 101 determines whether or not the duration time of the touch operation by the user is shorter than a predetermined time. The predetermined time is a time that becomes a threshold value for automatically performing opening and closing of the window glass 40. When the user touches any one of the GUI components 51 to 54 provided to open and close the window glass 40 for a predetermined time or more, it is considered that the user desires to fully open or fully close the window glass 40. In such a case, in the present disclosure, the power window 33 is automatically actuated until the window glass 40 is brought to a fully opened or fully closed state. When the input unit 101 makes a positive determination in step S112, the process proceeds to step S109, and the output unit 102 continuously outputs, to the power window 33, a command corresponding to the identified GUI component. Meanwhile, when the input unit 101 makes a negative determination in step S112, the process proceeds to step S113.

In step S113, the output unit 102 outputs an auto-command to the power window 33 so that the window glass 40 is automatically opened or closed. The auto-command is a command that continuously actuates the power window 33 until the window glass 40 that is in a raised state or a lowered state at the current time point is fully opened or fully closed. After the auto-command is output from the output unit 102, the actuation of the power window 33 is continued even when the user separates the finger from the touch panel 25.

In step S114, the output unit 102 outputs information relating to an answerback corresponding to the auto-command. The answerback is means for notifying the user that the opening or closing of the window glass 40 is automatically performed. The answerback may be, for example, outputting a predetermined sound. In this case, the output unit 102 outputs a signal for outputting the predetermined sound to a speaker. Further, the answerback may be, for example, vibrating the outer display 23. In this case, the output unit 102 may output, to the outer display 23, a command to actuate a vibrator included in the outer display. Further, as another example of the answerback, the output unit 102 may blink a predetermined lamp or blink the outer display 23 or the inner display 22. After that, the process returns to step S103.

As described above, according to the present embodiment, with the power window operation screen 50 being displayed on the outer display 23, the driver can operate the power window 33 without greatly shifting the driver's line of sight from the front side. Further, with the power window operation screen 50 being displayed on the outer display 23, as compared with the case of displaying the power window operation screen 50 on the inner display 22, the power window operation screen 50 can be prevented from being operated by a passenger other than the driver.

### Second Embodiment

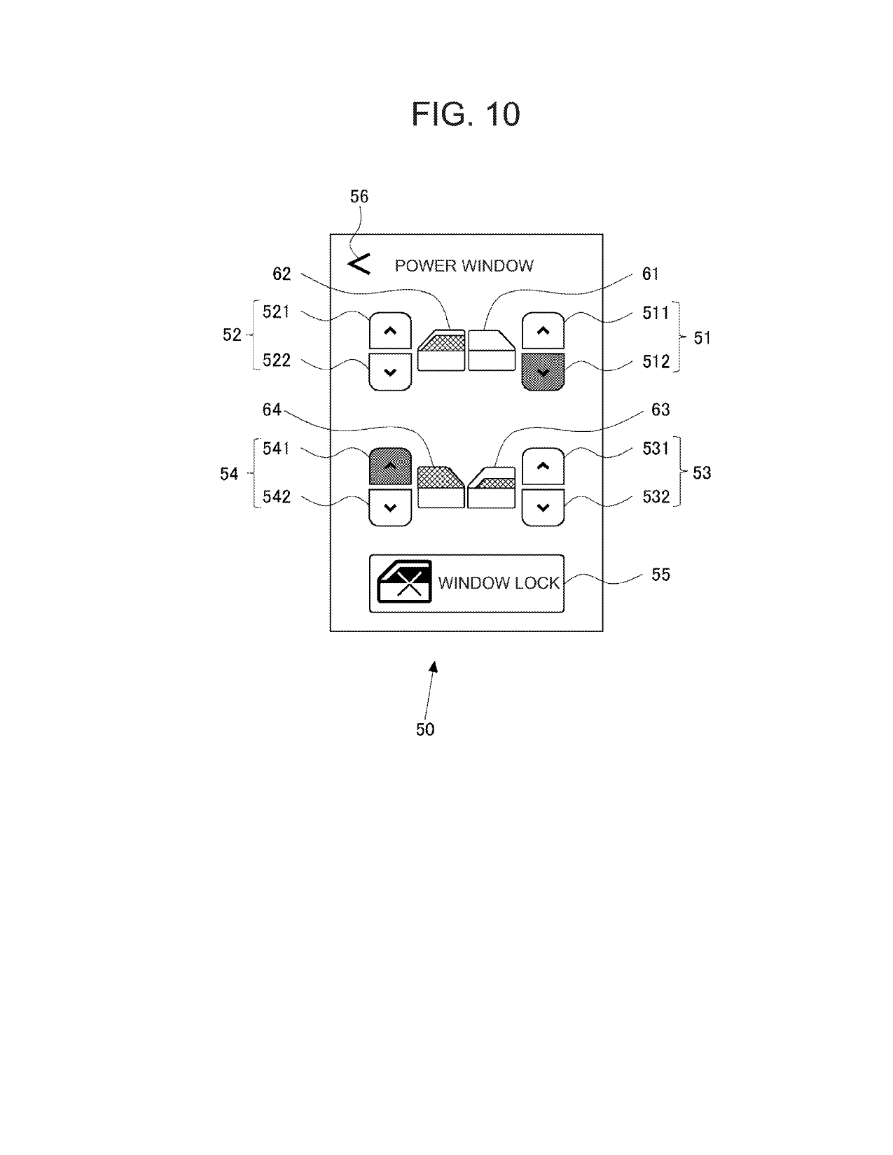

FIG. 10 is a view illustrating an example of the power window operation screen 50 to be displayed on the outer display 23 according to a second embodiment. In the example illustrated in FIG. 10, the power window operation screen 50 displays figures indicated by reference numerals 61 to 64 corresponding to opened or closed states of the window glasses 40. It is to be noted that the figures indicated by reference numerals 61 to 64 schematically show shapes of doors, and an upper half thereof corresponds to a window. In addition, the window glass 40 is hatched. It is to be noted that, in the example illustrated in FIG. 10, the window glass 40 is hatched, but, as another example, the window glass 40 may be colored with a different color (for example, light blue).

Reference numeral 61 represents the opened or closed state of the front right window glass 41. In the example illustrated in FIG. 10, the entire portion corresponding to the window is represented by white, and this represents that the front right window glass 41 is fully opened. Reference numeral 62 represents the opened or closed state of the front left window glass 42, and, in the example illustrated in FIG. 10, a part of the portion corresponding to the window is hatched. This hatched part is a part in which the front left window glass 42 is present, and the example illustrated in FIG. 10 shows a state in which the front left window glass 42 is opened by, for example, around 20%. Reference numeral 63 represents the opened or closed state of the rear right window glass 43, and, in the example illustrated in FIG. 10, a part of the portion corresponding to the window is hatched. This hatched part is a part in which the rear right window glass 43 is present, and the example illustrated in FIG. 10 shows a state in which the rear right window glass 43 is opened by, for example, around 50%. Reference numeral 64 represents the opened or closed state of the rear left window glass 44, and, in the example illustrated in FIG. 10, the entire portion corresponding to the window is hatched. This hatched part is a part in which the rear left window glass 44 is present, and the example illustrated in FIG. 10 shows a state in which the rear left window glass 44 is in a fully closed state.

It is to be noted that, in the example illustrated in FIG. 10, the opening degree of the window glass 40 is shown by a schematic view of the door, but the present disclosure is not limited thereto. For example, the opening degree of the window glass 40 may be shown by numerical values or letters.

Further, in the example illustrated in FIG. 10, a GUI component that cannot be operated is grayed out. For example, the front right window glass 41 is in a fully opened state, and hence the front right window glass 41 cannot be lowered any more. Accordingly, the GUI component 512 provided to lower the front right window glass 41 is grayed out. Further, for example, the rear left window glass 44 is in a fully closed state, and hence the rear left window glass 44 cannot be raised any more. Accordingly, the GUI component 541 provided to raise the rear left window glass 44 is grayed out. As described above, the output unit 102 changes a display mode between a GUI component that can be operated and a GUI component that cannot be operated.

It is to be noted that, in the example illustrated in FIG. 10, the GUI component that cannot be operated is grayed out, but the present disclosure is not limited thereto. For example, a GUI component that cannot be operated may be hidden.

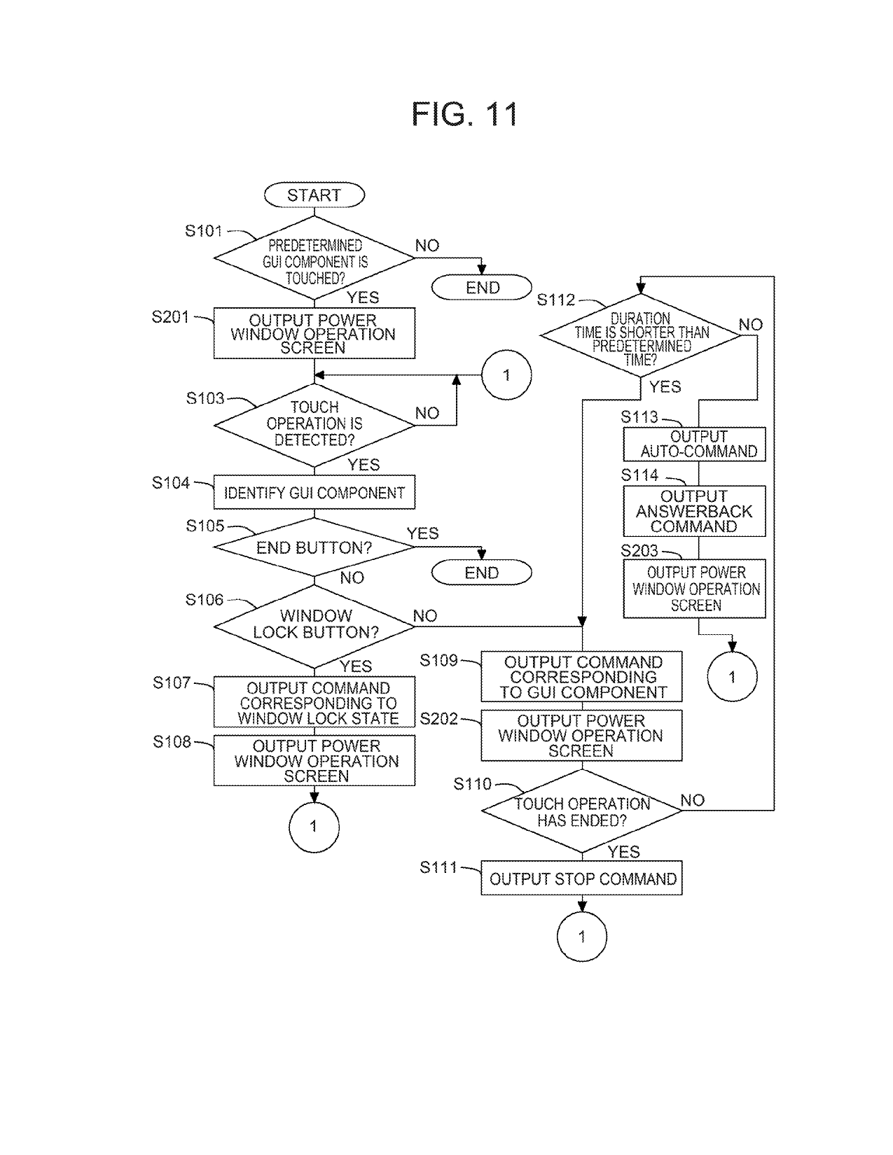

FIG. 11 is a flowchart of a process in the ECU 10 at the time of operating the power window 33 by the power window operation screen 50 according to the second embodiment. The process illustrated in FIG. 11 is repeatedly executed in the ECU 10 at every predetermined time. In the routine illustrated in FIG. 11, a step in which the same process as the process illustrated in FIG. 9 is executed is denoted by the same reference symbol, and description thereof is omitted.

In the routine illustrated in FIG. 11, when the input unit 101 makes a positive determination in step S101, the process proceeds to step S201. In step S201, the output unit 102 outputs the power window operation screen 50 to the outer display 23. At this time, the output unit 102 identifies a text to be displayed on the window lock button 55 in accordance with the state of the window lock stored in the storage unit 110. This is similar to the process of step S102.

Further, the input unit 101 generates figures corresponding to reference numeral 61 to reference numeral 64 illustrated in FIG. 10, in accordance with information relating to the opening degree of the window glass 40. The information relating to the opening degree of the window glass 40 may be stored in the storage unit 110, information detected by an opening degree sensor included in the power window 33 may be acquired, or the information relating to the opening degree of the window glass 40 may be information calculated by the input unit 101 in accordance with a rotational angle of a motor of the power window 33 or information calculated by the input unit 101 in accordance with an actuation time of the power window 33. The rotational angle of the motor of the power window 33 may be acquired by the input unit 101 from the power window 33. Further, the actuation time of the power window 33 may be a time from which the output unit 102 outputs a command in step S109 to when a stop command is output in step S111. As another example, when the power window 33 is actuated, the information relating to the opening degree of the window glass 40 may be transmitted from the power window 33 to the control unit 100, and the input unit 101 may store the information relating to the opening degree of the window glass 40 into the storage unit 110.

Then, the output unit 102 generates the power window operation screen 50 such that the power window operation screen 50 as illustrated in FIG. 10 is displayed, in accordance with the state of the window lock and the opening degree of the window glass 40. At this time, the output unit 102 identifies and grays out the GUI component that cannot be operated. The output unit 102 transmits, to the outer display 23, a command to cause the outer display 23 to display the generated power window operation screen 50.

Further, in the routine illustrated in FIG. 11, a process of step S202 is executed after the process of step S109. In step S202, the output unit 102 outputs the power window operation screen 50 to the outer display 23. At this time, the output unit 102 acquires the information relating to the opening degree of the window glass 40 in real time, and reflects the information onto the power window operation screen 50. In this manner, while the window glass 40 is opened or closed, the output unit 102 displays an animation of the opening degree of the window glass 40 indicated by each of reference numeral 61 to reference numeral 64 of the power window operation screen 50. It is to be noted that, as another example, when a positive determination is made in step S110, the output unit 102 may output the power window operation screen 50 to the outer display 23. In this case, with the use of the end of the touch operation by the user as a trigger, the opening degree of the window glass 40 after the operation of the power window 33 is reflected onto the power window operation screen 50.

Further, in the routine illustrated in FIG. 11, a process of step S203 is executed after the process of step S114. In step S203, the output unit 102 outputs the power window operation screen 50 to the outer display 23. At this time, the output unit 102 acquires the information relating to the opening degree of the window glass 40 in real time, and reflects the information onto the power window operation screen 50. For example, while the window glass 40 is opened or closed, the output unit 102 may display an animation of the opening degree of the window glass 40 indicated by each of reference numeral 61 to reference numeral 64 of the power window operation screen 50. Further, for example, the speed of the raising or the lowering of the window glass 40 may be measured in advance, and an animation may be displayed in accordance with the speed. It is to be noted that, as another example, the output unit 102 may generate the power window operation screen 50 and output the generated power window operation screen 50 to the outer display 23 such that the opening degree of the window glass 40 after the operation end is reflected after the automatic operation is ended.

As described above, with the present embodiment, the power window operation screen 50 is displayed on the outer display 23, and thus the driver can operate the power window 33 without greatly shifting the driver's line of sight from the front side. Further, the opening degree of each window glass 40 is displayed on the outer display 23, and hence the driver is not required to visually check the opening degree of each window glass 40.

### Third Embodiment

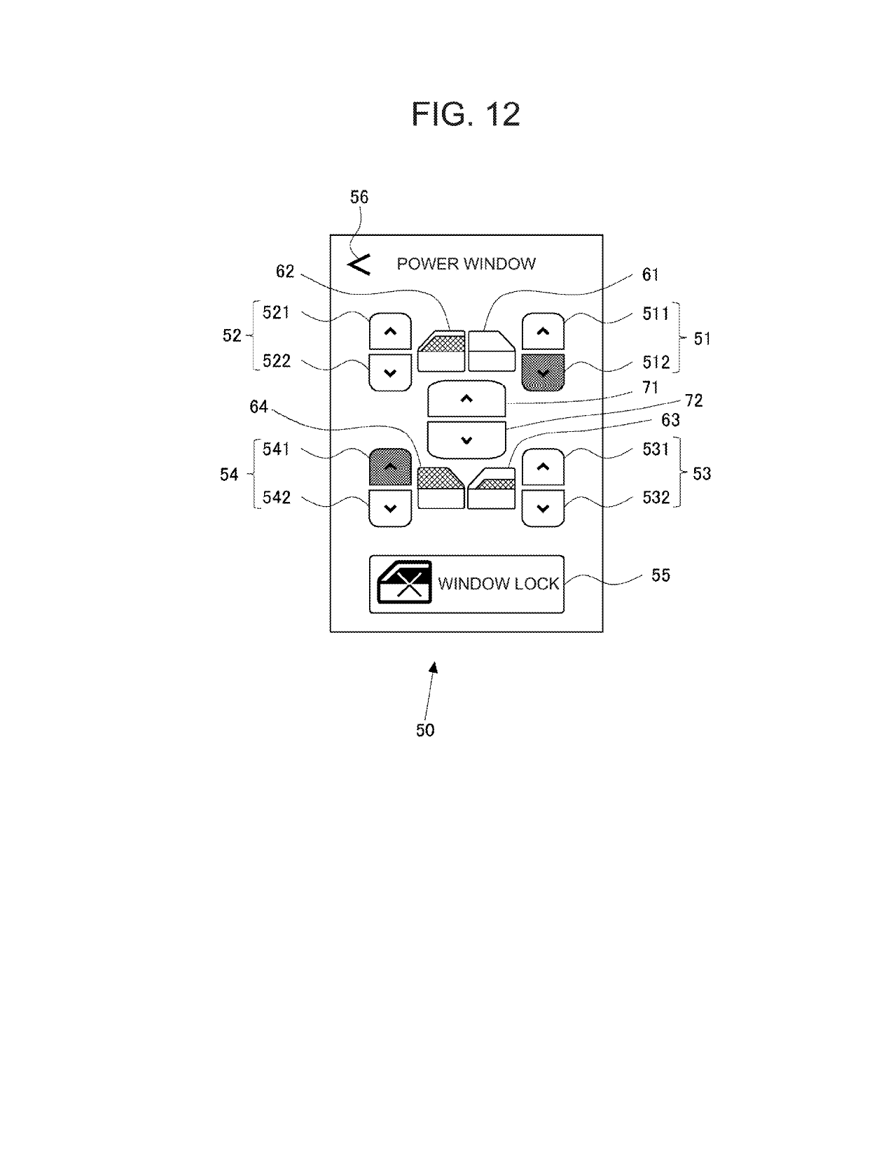

FIG. 12 is a view illustrating an example of the power window operation screen 50 to be displayed on the outer display 23 according to a third embodiment. In the example illustrated in FIG. 12, the power window operation screen 50 includes a GUI component 71 provided to raise all of the window glasses 40 at the same time, and a GUI component 72 provided to lower all of the window glasses 40 at the same time. When the input unit 101 determines that the GUI component 71 has been touched, the output unit 102 transmits a command to the power window 33 so that all of the window glasses 40 are raised. Meanwhile, when the input unit 101 determines that the GUI component 72 has been touched, the output unit 102 transmits a command to the power window 33 so that all of the window glasses 40 are lowered.

As described above, with the present embodiment, the power window operation screen 50 is displayed on the outer display 23, and thus the driver can collectively operate the window glasses 40 without greatly shifting the driver's line of sight from the front side.

### Other Embodiments

The above-mentioned embodiment is merely an example, and the present disclosure may be carried out by applying changes as appropriate within a scope not departing from the gist thereof. The processes and means described in the present disclosure can be freely implemented in combination as long as there is no technical confliction generated thereby. Further, a process described as being performed by one device may be allotted to be executed by a plurality of devices. Alternatively, a process described as being performed by different devices may be executed by one device. In a computer system, it is possible to flexibly change which hardware configuration is to implement each of the functions.

The present disclosure can be carried out by providing a computer program for implementing the functions described in the above-mentioned embodiment to a computer and causing one or more processors included in the computer to read and execute the program. Such a computer program may be provided to the computer via a non-transitory computer readable storage medium that is connectable to a system bus of the computer or may be provided to the computer via a network. Examples of the non-transitory computer readable storage medium include any types of disks such as magnetic disks (a Floppy (registered trademark) disk, a hard disk drive (HDD), and the like) and optical discs (a CD-ROM, a DVD disc, a Blu-ray disc, and the like), a read-only memory (ROM), a random access memory (RAM), an EPROM, an EEPROM, a magnetic card, a flash memory, an optical card, and any types of media suited for storing electronic instructions.

What is claimed is:

1. An in-vehicle system comprising:
a display device;
a power window configured to electrically open and close a window glass of a vehicle; and
an information processing device configured to output information via the display device, wherein:
the display device is provided at a front portion of a driver's seat in a vehicle cabin;
the display device includes a pair of display units disposed at positions on both lateral sides of a steering wheel while protruding to a vehicle rear side of an instrument unit provided in front of the steering wheel, the display units each including a touch panel;
the information processing device includes a control unit and a storage unit; and
the control unit is configured to:
output, in accordance with a signal received from the touch panel and information stored in the storage unit, a command to cause the display units to display an operation screen for the power window, to the display device;
identify a touch operation to the operation screen for the power window in accordance with a signal from the touch panel; and
output, to the power window, a command to open or close the window glass in accordance with the identified touch operation.

2. An in-vehicle system comprising:
a display device; and
an information processing device configured to output information via the display device, wherein:
the display device is provided at a front portion of a driver's seat in a vehicle cabin;
the display device includes a pair of display units disposed at positions on both lateral sides of a steering wheel while protruding to a vehicle rear side of an instrument unit provided in front of the steering wheel, the display units each including a touch panel; and
the information processing device includes a control unit configured to output, to the display device, a command to cause the display units to display an operation screen for a power window that electrically opens and closes a window glass of a vehicle.

3. The in-vehicle system according to claim 2, wherein the display units are disposed on a vehicle front side of a grasping portion of the steering wheel in a front-rear direction of the vehicle.

4. The in-vehicle system according to claim 2, wherein the control unit is configured to:
receive, from the display device, a touch signal relating to a touch operation to the touch panel; and
output, in accordance with the touch signal, a command to open or close the window glass to the power window.

5. The in-vehicle system according to claim 2, wherein the control unit is configured to:
acquire information relating to an opening degree of the window glass; and
output the command to the display device such that the information relating to the opening degree of the window glass is displayed on the operation screen for the power window.

6. The in-vehicle system according to claim 2, wherein the control unit is configured to output the command to the display device such that, in the operation screen for the power window, a display mode is changed between an interface by which the window glass is operatable and an interface by which the window glass is not operatable.

7. The in-vehicle system according to claim 2, wherein:
the display units are configured to include an inner display disposed closer to an inner side of the vehicle, and an outer display disposed closer to an outer side of the vehicle; and
the control unit is configured to output the command to the display device such that the operation screen for the power window is displayed on the outer display.

8. The in-vehicle system according to claim 2, wherein the control unit is configured to:
receive, from the display device, a touch signal relating to a touch operation to the touch panel;
output, when it is determined in accordance with the touch signal that an interface corresponding to an operation of opening the window glass is touched for a predetermined time or more, a command to automatically fully open the window glass to the power window; and
output, when it is determined in accordance with the touch signal that an interface corresponding to an operation of closing the window glass is touched for a predetermined time or more, a command to automatically fully close the window glass to the power window.

9. An information processing device that outputs information via a display device, the information processing device comprising:
a control unit, wherein:
the display device is provided at a front portion of a driver's seat in a vehicle cabin;
the display device includes a pair of display units disposed at positions on both lateral sides of a steering wheel while protruding to a vehicle rear side of an instrument unit provided in front of the steering wheel, the display units each including a touch panel; and
the control unit is configured to output, to the display device, a command to cause the display units to display an operation screen for a power window that electrically opens and closes a window glass of a vehicle.

10. The information processing device according to claim 9, wherein the display units are disposed on a vehicle front side of a grasping portion of the steering wheel in a front-rear direction of the vehicle.

11. The information processing device according to claim 9, wherein the control unit is configured to:
receive, from the display device, a touch signal relating to a touch operation to the touch panel; and
output, in accordance with the touch signal, a command to open or close the window glass to the power window.

12. The information processing device according to claim 9, wherein the control unit is configured to:
acquire information relating to an opening degree of the window glass; and
output the command to the display device such that the information relating to the opening degree of the window glass is displayed on the operation screen for the power window.

13. The information processing device according to claim 9, wherein the control unit is configured to output the command to the display device such that, in the operation screen for the power window, a display mode is changed between an interface by which the window glass is operatable and an interface by which the window glass is not operatable.

14. The information processing device according to claim 9, wherein:
the display units are configured to include an inner display disposed closer to an inner side of the vehicle, and an outer display disposed closer to an outer side of the vehicle; and
the control unit is configured to output the command to the display device such that the operation screen for the power window is displayed on the outer display.

15. The information processing device according to claim 9, wherein the control unit is configured to:
receive, from the display device, a touch signal relating to a touch operation to the touch panel;
output, when it is determined in accordance with the touch signal that an interface corresponding to an operation of opening the window glass is touched for a predetermined time or more, a command to automatically fully open the window glass to the power window; and
output, when it is determined in accordance with the touch signal that an interface corresponding to an operation of closing the window glass is touched for a predetermined time or more, a command to automatically fully close the window glass to the power window.
